(19) United States
(12) Patent Application Publication
(10) Pub. No.: US 2021/0005027 A1
(43) Pub. Date: Jan. 7, 2021

(54) SYSTEM AND METHOD FOR BATTERY MAINTENANCE MANAGEMENT

(71) Applicants: Daniel Handiaz, Toronto (CA); Danyel Perote, Toronto (CA)

(72) Inventors: Daniel Handiaz, Toronto (CA); Danyel Perote, Toronto (CA)

(73) Assignee: QodeLogix Systems Inc., Brampton (CA)

(21) Appl. No.: 16/503,495

(22) Filed: Jul. 4, 2019

(51) Int. Cl. G07C 5/00; G06N 20/00; G06N 5/04; G07C 5/08; H04W 4/44; G01W 1/10

(52) U.S. Cl. CPC G07C 5/008; G06N 20/00; G01W 1/10; G07C 5/085; H04W 4/44; G06N 5/04

(57) ABSTRACT

A system and method for predicting a battery charge depletion of a vehicle are disclosed. The system further configured to classify the vehicles according to the extracted data and generate a battery maintenance schedule for each vehicle. The system comprises an analytical data module, a remote computing system, and a weather forecast module. The analytical data module is configured to extract data, for example, battery status, from the vehicle. The weather forecast module is configured to detect weather forecasts for an area in which the vehicle is located. The remote computing system comprises a battery depletion prediction module, a machine learning module, and a database. The battery depletion prediction module is configured to predict the battery charge depletion based on the extracted data and weather forecasts using the machine learning algorithm. The remote computing system is connected to a user device to transfer the predicted battery status of the vehicle.

### BACKGROUND OF THE INVENTION

### A. Technical Field

The present invention relates generally to a battery management system. More specifically, the present invention relates to a system and method for monitoring the state or condition of a battery and predicting the risk of battery drainage in real-time in a vehicle.

### B. Description of Related Art

Vehicle engines include an energy storage device, such as batteries for powering a starter motor and supporting electrical load transients. The battery-powered vehicles are used for various applications such as fleets, where a numerous number of vehicles are maintained by a single business. In some case, the vehicles within the single fleet may have different rechargeable battery technologies such as sealed batteries, lead acid batteries or lithium-ion batteries. Different battery technologies use different charging methodologies or algorithms. Further, the battery chargers are designed to charge a specific type of battery. Hence, different battery chargers are needed to charge different vehicles within a single fleet.

Managing a fleet of vehicles is a difficult task. It requires human resources investment to ensure manual maintenance tasks, and investments in terms of IT infrastructure to optimize human intervention in fleet management to eliminate the complexity and expense of managing hundreds, even thousands of vehicles. Among them, vehicle battery maintenance is one of the most complex tasks in fleet management. Maintaining a large fleet of batteries is frustrating, time-consuming and costly. For fleet maintenance managers, battery maintenance is both a field performance issue as well as a budget consideration.

The cars/vehicles remain idle on the lots until they are sold. Due to the idle state of vehicles on a lot or insufficient charging by solar panel, the batteries of such vehicles become discharged to the extent that they have insufficient capacity for starting the engine or may be completely drained to the extent that the battery must be replaced. Such discharging may be caused by a number of factors including a battery is defective, natural time decay exacerbated by abnormally cold temperatures, or a battery having been drained by a current. If a battery level goes too low, the lot manager must recharge the battery using solar panels. Many dealers proactively place portable solar charging units under the windshield of each vehicle. Again, this becomes subject to the availability and intensity of sunlight. During months of reduced sunlight and heavy cloud, snow, rain, regions that are predominantly overcast, or during snowfall, the efficacy of the portable solar as a deterrent to battery drainage becomes seriously reduced.

One major problem facing dealers is that the car dealer managers must actively monitor the battery levels on a daily basis to maintain warranty coverage from the manufacturer. Furthermore, during winter, batteries can struggle due to a lower temperature and battery-related breakdowns are even more likely to occur. Low temperatures accelerate the battery depletion velocity. Many car dealers are not monitoring and charging the batteries in a regular manner rather they just replace the battery once it dies. Few existing patent references attempted to address the aforesaid problem are cited in the background as prior art over the presently disclosed subject matter and are explained as follows:

A prior art, U.S. Pat. No. 5,801,618 A to Mark Jenkins, discloses a vehicle alarm and lot monitoring system having a plurality of remote programmable RF transponder/sensor node units installed on individual vehicles which may be programmed to detect the condition of the vehicle battery and transmit a corresponding signal to a central server unit to identify the vehicle having a weak battery.

Another prior art, U.S. Pat. No. 7,672,756 B2 to David S. Breed, discloses a system for diagnosing components in a vehicle and the operating status of the vehicle and alerting the vehicle's manufacturer, agent or dealer, or another repair facility, via a telematics link that a component of the vehicle is functioning abnormally and may be in danger of failing.

The above-mentioned prior art discloses about fleet management solutions and battery maintenance systems. However, they fail to provide accurate information on the battery level, as well as its evolution over time-based on external factors, such as weather conditions. Hence, the existing fleet management and battery maintenance solutions tend to be less useful, less efficient and less productive.

In light of the above-mentioned drawbacks, there exist a need for system and method for monitoring the state or condition of a battery and predicting the risk of battery drainage in real-time in a vehicle based on external factors that affect the life cycle of the batteries in the vehicle.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

The present invention discloses a battery maintenance management system for a fleet of vehicle. The system is configured to detect and predict the vehicle's battery charge depletion based on the extracted data and weather forecasts for an area in which the vehicle is located. The system is configured to identify the vehicles have batteries that seem to be losing their charge at the fastest velocity. In one embodiment, the system comprises an analytical data module, a transmission module, a remote computing system, and a weather forecast module.

In one embodiment, the analytical data module is configured to extract data from the vehicle. The analytical data module is securely positioned in the vehicle. The extracted data includes, but not limited to, a vehicle identification number, fuel level, battery level, vehicle mileage, and GPS location. In one embodiment, the analytical data module is at least any one of, but not limited to, an onboard computer system, a vehicle operating system, and an onboard diagnostics (OBD). In one embodiment, the analytical data module is configured to wirelessly communicate to the remote computing system in real-time via a real-time operating system (RTOS) and the transmission module. In one embodiment, the transmission module includes a cellular chip. In one embodiment, the weather forecast module is configured to detect the weather forecasts for an area in which the vehicle is located. In one embodiment, the weather forecast module is securely positioned in the remote computing system. The weather forecast module is further connected to a weather forecast service provider to retrieve the meteorological information, for example, temperature, associated with the location of each fleet vehicle. In one embodiment, the weather forecast module is an application programming interface (API).

In one embodiment, the remote computing system further comprises, but not limited to, a battery depletion prediction module, a machine learning module, and a database. In one embodiment, the remote computing system is configured to receive the extracted data from the analytical data module via the transmission module and weather forecasts data from the weather forecast module. In one embodiment, the server is configured to host communications between the remote computing system, the analytical data module, and the weather forecast module. In one embodiment, the database is configured to store the extracted data and weather forecasts data received from the analytical data module and the weather forecast module, respectively. In one embodiment, the machine learning module is configured to test and update the database and forecast the extracted data and weather forecasts data received from the analytical data module in real-time and the weather forecast module, respectively.

In one embodiment, the remote computing system is further comprising a battery depletion prediction module. The battery depletion prediction module is configured to detect and predict the vehicle's battery charge depletion based on the vehicle's extracted data and weather forecasts using the machine learning algorithm. In one embodiment, the remote computing system is further configured to connect to a user device via an application programming interface (API) to transfer data related to the vehicle's location, predicted battery charge depletion, fuel level, and mileage of the vehicle. In one embodiment, the user device is at least any one of a desktop, a laptop, a tablet, a smartphone, a personal digital assistant (PDA), and mobile and/or handheld electronic device. In one embodiment, the system is further configured to classify the vehicles according to the priority of charging their batteries and generate a battery maintenance schedule for each fleet vehicle. In one embodiment, the vehicle is at least any one of, but not limited to, cars, trucks, buses, semi-trucks, semi-trucks with trailer, tractor trailers, trailers, recreational vehicles (RVs), sport utility vehicle SUVs, campers, limousines, cabs, and vans.

In one embodiment, a method for maintaining a battery of a fleet of vehicle is disclosed. In one embodiment, the method is used to detect and predict the vehicle's battery charge depletion based on the extracted data and weather forecasts for an area in which the vehicle is located. At one step, the analytical data module extracts the data of each fleet vehicle. In one embodiment, the extracted data includes, but not limited to, a vehicle identification number, fuel level, battery level, vehicle mileage, and GPS location. At another step, the extracted data is transmitted to the remote computing system from the analytical data module via the transmission module. In one embodiment, the transmission module includes a cellular chip. At another step, weather forecasts are determined for an area in which the vehicle is located using a weather forecast module. In one embodiment, the weather forecast module is further connected to a weather forecast service provider to retrieve the meteorological information associated with the location of each vehicle. At another step, the extracted data and weather forecasts are received from the analytical data module and the weather forecast module, respectively, are stored in a database of the remote computing device. Further, at another step, the vehicle's battery charge depletion is detected and predicted based on the extracted data and weather forecasts using a battery depletion prediction module using the machine learning algorithm.

In one embodiment, a non-transitory physical computer storage could be provided that includes instructions stored thereon for implementing, in one or more processors, a method of managing the maintenance of batteries of a fleet of vehicles is disclosed. At one step, the analytical data module extracts the data of each fleet vehicle. At another step, the extracted data is transmitted to the remote computing system from the analytical data module via the transmission module. At another step, weather forecasts are determined for an area in which the vehicle is located using a weather forecast module. At another step, the extracted data and weather forecasts are received from the analytical data module and the weather forecast module, respectively, are stored in a database of the remote computing device. Further, at another step, the vehicle's battery charge depletion is detected and predicted based on the extracted data and weather forecasts using a battery depletion prediction module using the machine learning algorithm.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a block diagram of a system for battery maintenance management, according to an embodiment of the present invention;

FIG. 2 exemplarily illustrates a method for a battery maintenance management, according to an embodiment of the present invention;

FIG. 3 exemplarily illustrates a flow diagram of a battery maintenance management system, according to an embodiment of the present invention;

FIGS. 4A-4B exemplarily illustrates a flowchart of a process for forecasting data and predicting the battery charge depletion of a vehicle using the machine learning algorithm, according to an embodiment of the present invention;

FIG. 5 exemplarily illustrates a screenshot of the user interface of the battery maintenance management system, according to an embodiment of the present invention.

Other features, advantages, and aspects of the present invention will become more apparent and be more readily understood from the following detailed description, which should be read in conjunction with the accompanying drawings.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Reference will now be made in detail to various embodiments. Each example is provided by way of explanation, and is not meant as a limitation and does not constitute a definition of all possible embodiments. The described embodiments are to be considered in all respects only as illustrative and not restrictive. For purposes of illustrating features of the embodiments, a simple example will now be introduced and referenced throughout the disclosure. Those skilled in the art will recognize that this example is illustrative and not limiting and is provided purely for explanatory purposes. An example of a computing system environment is disclosed. The computing system environment is not intended to suggest any limitation as to the scope of use or functionality of the system and method described herein. Neither should the computing environment be interpreted as having any dependency or requirement relating to any one or combination of components illustrated in the exemplary operating environment.

Embodiments of the disclosure are operational with numerous other general purposes or special purpose computing system environments or configurations. Examples of well-known computing systems, environments, and/or configurations that may be suitable for use with the systems and methods described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The embodiments of the disclosure may be described in the general context of computer-executable instructions, such as program modules, being executed by a computer. Generally, program modules include routines, programs, objects, components, data structures, etc. that perform particular tasks or implement particular abstract data types. The systems and methods described herein may also be practiced in distributed computing environments where tasks are performed by remote processing devices that are linked through a communications network. In a distributed computing environment, program modules may be located in both local and remote computer storage media including memory unit or storage devices. Tasks performed by the programs and modules are described below and with the aid of figures. Those skilled in the art can implement the exemplary embodiments as processor executable instructions, which can be written on any form of a computer readable media in a corresponding computing environment according to this disclosure.

Components of a computer may include, but are not limited to, a processing unit, a system memory, and a system bus that couple various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer includes a variety of computer-readable media. Computer readable media can be any available media that can be accessed by the computer and includes both volatile and non-volatile media, removable and non-removable media. By way of example, and not limitation, computer-readable media may include computer storage media and communication media. Computer storage media includes both volatile and non-volatile, removable and non-removable media implemented in any method or technology for storage of information such as computer readable instructions, data structures, program modules or other data. Computer storage media includes, but not limited to, Random Access Memory (RAM), Read-Only Memory (ROM), Electrically Erasable Read-Only Memory (EEPROM), flash memory or other memory technology, Compact Disk Read-Only Optical Memory (CD-ROM), digital versatile disks (DVD) or other optical disk storage, magnetic cassettes, magnetic tape, magnetic disk storage or other magnetic storage devices, or any other medium which can be used to store the desired information and which can be accessed by computer.

Communication media embodies one or more of computer readable instructions, data structures, program modules, and the like, and/or other data in a modulated data signal such as a carrier wave or other transport mechanism, and may include any known information delivery media consistent with this disclosure. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory includes computer storage media in the form of volatile and/or non-volatile memory such as read-only memory (ROM) and random-access memory (RAM). A basic input/output system (BIOS), containing the basic routines that help to transfer information between elements within the computer, such as during start-up, may be stored in ROM. RAM may contain data and/or program modules that are readily accessible by a processing unit. By way of example, and not limitation, such as data and/or program modules may include an operating system, application programs, other program modules, and program data.

The computer may also include other removable/non-removable volatile/non-volatile computer storage media. By way of example only, a hard disk drive that reads from or writes to non-removable, non-volatile magnetic media, a magnetic disk drive that reads from or writes to a removable, non-volatile magnetic disk, and an optical disk drive that reads from or writes to a removable, non-volatile optical disk such as a CD ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive may be connected to the system bus through a non-removable memory interface, and magnetic disk drive and optical disk drive may be connected to the system bus by a removable memory interface.

The drives and their associated computer storage media provide storage of computer readable instructions, data structures, program modules and other data for the computer. For example, hard disk drive disclosed stores operating system, application programs, other program modules, and program data. Each of the storing operating system, the application programs, the other program modules, and the program data may be the same as or different from the operating system, the application programs, the other program modules, and the program data described hereinabove. The operating system, the application programs, the other program modules, and the program data are given different numbers here to illustrate that, at a minimum, they are different copies.

A user may enter commands and information into the computer through input devices such as a keyboard, a microphone, and a pointing device, such as a mouse, trackball or touch pad. Other input devices (not shown) may include a joystick, game pad, satellite dish, scanner, or the like. These and other input devices may be connected to the processing unit through a user input interface that is coupled to the system bus, but may be connected by other interface and bus structures, such as a parallel port, game port or a universal serial bus (USB). A monitor or other type of display device is also connected to the system bus via an interface, such as a video interface. In addition to the monitor, computers may also include other peripheral output devices such as speakers and printer, which may be connected through an output peripheral interface.

The computer may operate in a networked environment using logical connections to one or more remote computers, such as a remote computer. The remote computer may be a personal computer, a hand-held device, a server, a router, a network PC, a peer device or other common network node, and may include one, more or all of the elements described above relative to the computer. The logical connections include a local area network (LAN) and a wide area network (WAN). It is contemplated that the logical connections may include other networks. These other networks may be included in combination with the LAN and WAN. Such networking environments are commonplace in offices, enterprise-wide computer networks, intranets and the Internet.

When used in a LAN networking environment, the computer is connected to the LAN through a network interface or adapter. When used in a WAN networking environment, the computer includes a modem or other means for establishing communications over the WAN, such as the Internet. The modem, which may be internal or external, may be connected to the system bus via the user input interface, or another appropriate mechanism. In a networked environment, program modules depicted relative to the computer, or portions thereof, may be stored in a remote memory unit or storage device. It will be appreciated that the network connections shown are exemplary and other means of establishing a communications link between the computers may be used.

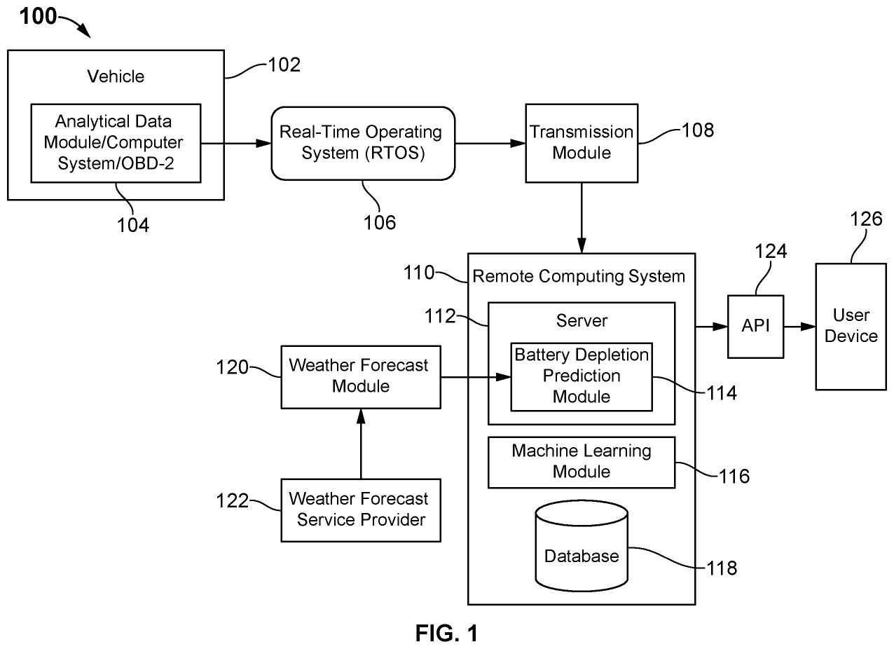

Referring to FIG. 1, a battery maintenance management system 100 for a fleet of vehicle 102 is disclosed. The system 100 is configured to detect and predict the vehicle's battery charge depletion based on the extracted data and weather forecasts for an area in which the vehicle 102 is located. The system 100 is configured to identify the vehicles have batteries that seem to be losing their charge at the fastest velocity. In one embodiment, the system 100 comprises an analytical data module 104, a transmission module 108, a remote computing system 110, and a weather forecast module 120.

In one embodiment, the analytical data module 104 is configured to extract data from the vehicle 102. The analytical data module 104 is securely positioned in the vehicle 102. The extracted data includes, but not limited to, a vehicle identification number, fuel level, battery level, vehicle mileage, and GPS location. In one embodiment, the analytical data module is at least any one of, but not limited to, an onboard computer system, a vehicle operating system, and an onboard diagnostics (OBD). In one embodiment, the analytical data module 104 is configured to wirelessly communicate to the remote computing system 110 in real-time via a real-time operating system (RTOS) 106 and the transmission module 108. In one embodiment, the transmission module 108 includes a cellular chip. In one embodiment, the weather forecast module 120 is configured to detect the weather forecasts for an area in which the vehicle 102 is located. In an exemplary embodiment, the weather forecast module 120 is configured to detect the weather forecasts for the next 3 days for an area in which the vehicle 102 is located. In one embodiment, the weather forecast module 108 is securely positioned in the remote computing system 110. The weather forecast module 120 is further connected to a weather forecast service provider 122 to retrieve the meteorological information, for example, temperature, associated with the location of each fleet vehicle 102. In one embodiment, the weather forecast module 120 is an application programming interface (API).

In one embodiment, the remote computing system 110 further comprises, but not limited to, a battery depletion prediction module 114, a machine learning module 116, and a database 118. In one embodiment, the remote computing system 110 is configured to receive the extracted data from the analytical data module 104 via the transmission module 108 and weather forecasts data from the weather forecast module 120. The remote computer system 110 then checks the battery level of each vehicle 102 and predicts the battery depletion of each vehicle 102 for at least, but not limited to, the next 3 days according to the meteorological information of the exact location of each vehicle 102. When the battery level at 30% or any other threshold value, the remote computer system 110 automatically generates an alert. In one embodiment, the system 100 then proceeds to the classification of vehicles according to the priority of charging their batteries and generates a schedule for the battery maintenance. In one embodiment, the server 112 is configured to host communications between the remote computing system 110, the analytical data module 104, and the weather forecast module 120. In one embodiment, the database 118 is configured to store the extracted data and weather forecasts data received from the analytical data module 104 and the weather forecast module 120, respectively. In one embodiment, the machine learning module 116 is configured to test and update the database 118 and forecast the extracted data and weather forecasts data received from the analytical data module 104 in real-time and the weather forecast module 120, respectively.

In one embodiment, the remote computing system 110 further comprises a battery depletion prediction module 114. The battery depletion prediction module 114 is configured to detect and predict the vehicle's battery charge depletion based on the vehicle's extracted data and weather forecasts for an area in which the vehicle is located using the machine learning algorithm. In order to improve the precision of the battery depletion prediction module 114, the remote computer system 110 uses a machine learning process executed by the battery depletion prediction module 114. In one embodiment, the remote computing system 110 is further configured to connect to a user device 126 via an application programming interface (API) 124 to transfer data related to the vehicle's location, predicted battery charge depletion, fuel level, and mileage of the vehicle 102. In one embodiment, the user device 126 is at least any one of a desktop, a laptop, a tablet, a smartphone, a personal digital assistant (PDA), and mobile and/or handheld electronic device. In one embodiment, the user device 126 is wirelessly communicated to the remote computing system 110 via a network using a software application. In one embodiment, the network is at least any one of, but not limited to, Wi-Fi, Bluetooth®, a wireless local area network (WLAN), and radio wave communication. In one embodiment, the system 100 is further configured to classify the vehicles according to the priority of charging their batteries and generate a battery maintenance schedule for each fleet vehicle. In one embodiment, the vehicle 102 is at least any one of, but not limited to, cars, trucks, buses, semi-trucks, semi-trucks with trailer, tractor trailers, trailers, recreational vehicles (RVs), sport utility vehicle SUVs, campers, limousines, cabs, and vans.

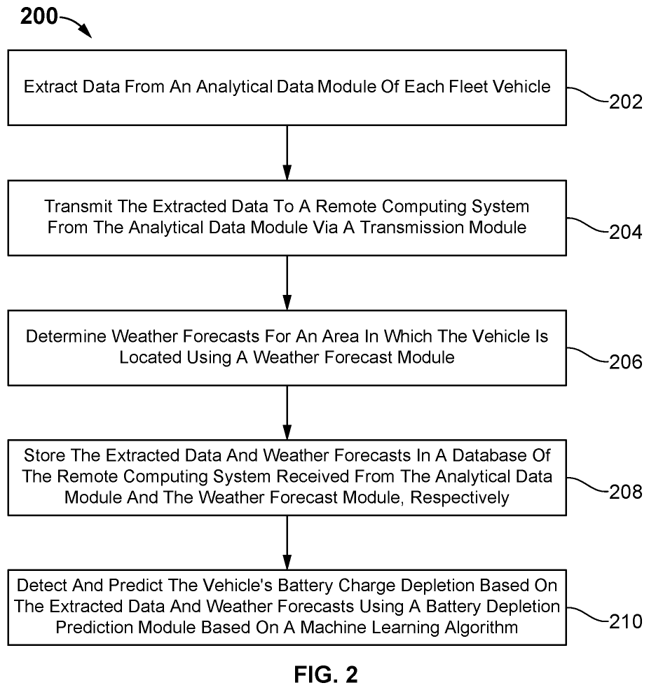

Referring to FIG. 2, a method 200 for maintaining a battery of a fleet of vehicle 102 (shown in FIG. 1) is disclosed. In one embodiment, the method 200 is used to detect and predict the vehicle's battery charge depletion based on the extracted data and weather forecasts for an area in which the vehicle 102 is located. At step 202, the analytical data module 104 (shown in FIG. 1) extracts the data of each fleet vehicle 102. The extracted data includes, but not limited to, a vehicle identification number, fuel level, battery level, vehicle mileage, and GPS location. In one embodiment, the analytical data module 104 is at least any one of, but not limited to, an onboard computer system, a vehicle operating system, and an onboard diagnostics (OBD). At step 204, the extracted data is transmitted to the remote computing system 110 (shown in FIG. 1) from the analytical data module 104 via the transmission module 108 (shown in FIG. 1). In one embodiment, the transmission module 108 includes a cellular chip. At step 206, weather forecasts are determined for an area in which the vehicle 102 is located using a weather forecast module 120 (shown in FIG. 1). In one embodiment, the weather forecast module 120 is further connected to a weather forecast service provider 122 (shown in FIG. 1) to retrieve the meteorological information associated with the location of each vehicle 102. At step 208, the extracted data and weather forecasts are received from the analytical data module 104 and the weather forecast module 120, respectively, are stored in a database 118 (shown in FIG. 1) of the remote computing device 110. At step 210, the vehicle's battery charge depletion is detected and predicted based on the extracted data and weather forecasts using a battery depletion prediction module 114 (shown in FIG. 1) using the machine learning algorithm.

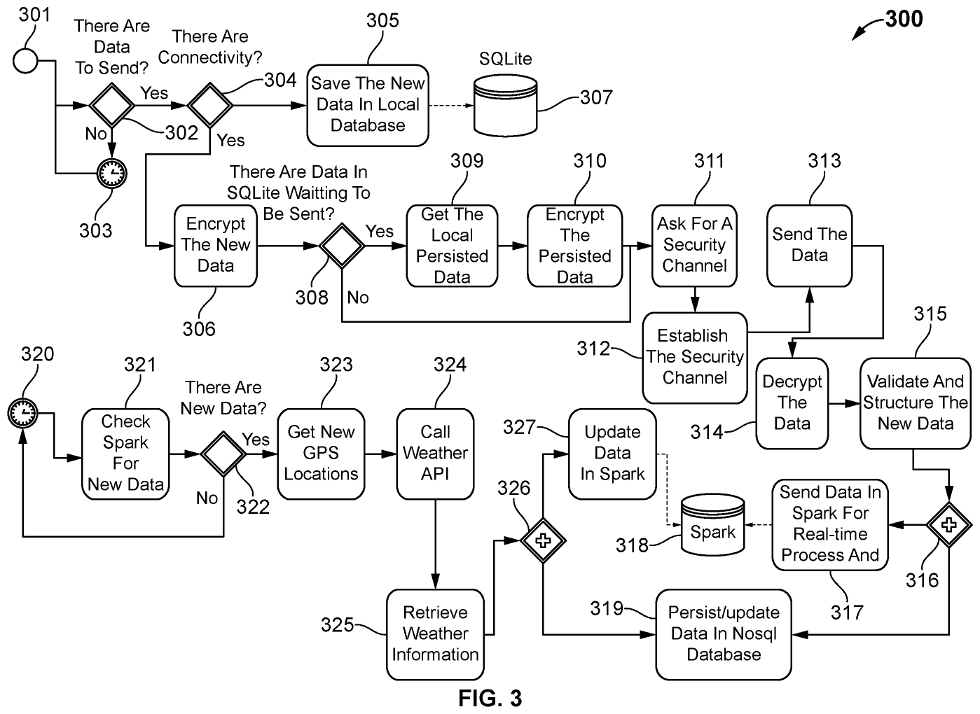

Referring to FIG. 3, a flow diagram 300 of the battery maintenance management system 100 is disclosed. At step 301, the system could receive one or more telematic data of the vehicle. At decision step 302, the system checks whether there is any reception of new data or not. If yes, the new data is transmitted to the next decision step 304. If no, the absence of data reception is monitored via a timer 303 in a regular interval of time. At decision step 304, the system checks whether there is any connectivity between the newly received data and previously stored data in a local database or not. If yes, the system encrypts the new data at step 306. If there is no connectively, the system saves the newly received data in a local database at step 305. In one embodiment, the local database could be an SQLite database 307.

At another decision step 308, the system checks whether there is any data in the database, for example, SQLite 307 is waiting to be sent for further processing. If there is no waiting of data in the database, for example, SQLite 307, the system directly sends a request for a security/secure channel to transmit the encrypted data at step 311. If there is waiting for data, the system gets the local persisted data from the database, for example, SQLite 307, at step 309 and encrypts the data for secured data transfer at step 310. After encryption, the system sends a request for the security channel to transmit the encrypted data at step 311. At step 312, a security channel is established based on the received request from the system. At step 313, the system sends the data via the security channel for data decryption at step 314. At step 315, the new decrypted data gets validated and structured for storing into the database. At step 316, the validated and structured data is transmitted one or more databases for storage. At step 317, the data transmitted to a general-purpose computing system or spark 318 for real-time process 317. In one embodiment, the spark 318 is an open-source distributed computing system or database for the storage of huge volume of data. In one embodiment, the database is accessible by the computing device. In another embodiment, the database is integrated into the server or separate from it. In some embodiments, the database resides in a connected server or in a cloud computing service. Regardless of location, the database comprises a memory to store and organize certain data for use by the server. At step 319, the system further uploads the validated and structured data in the database, for example, the NoSQL database.

At step 321, a timer 320 often checks the spark 318 for the reception of any new data in a regular interval of time. At another decision step 322, whether there is any new data received or not. If there is no new data in the spark, the system continues to check the reception of new data to spark. If there is new data in spark, the system gets new GPS locations of the vehicle and calls weather API to retrieve weather information of the new location at steps 323-325. At step 326, the retrieved weather information is updated in one or more databases. At step 327, the retrieved weather information is updated in spark 318. At step 319, the system updates the retrieved data in the NoSQL database. In one embodiment, the spark 318 is integrated into the server or separate from it.

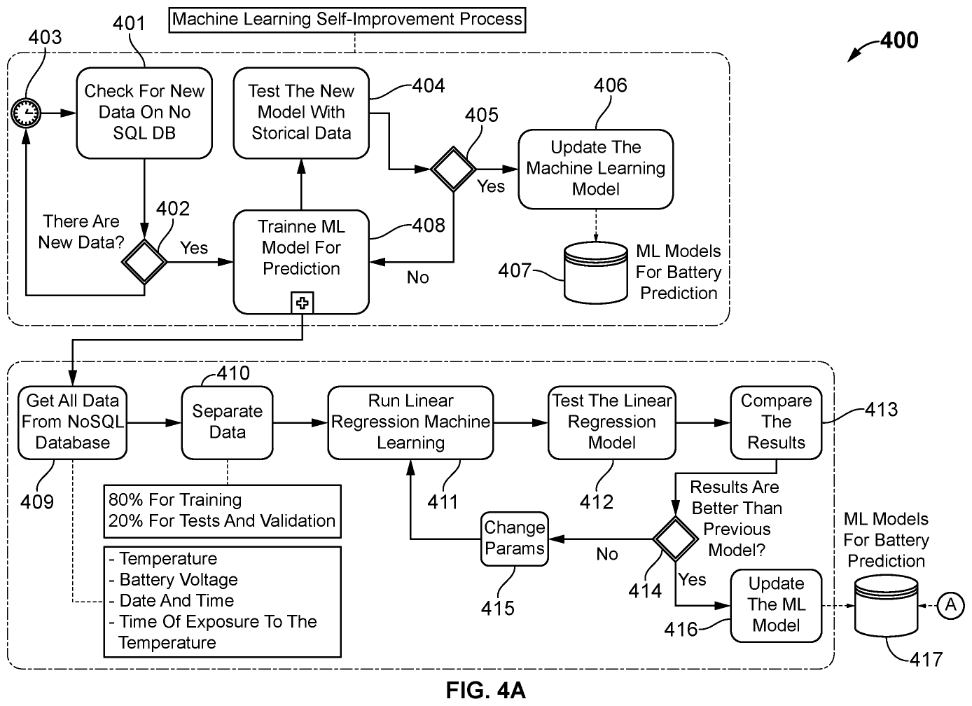

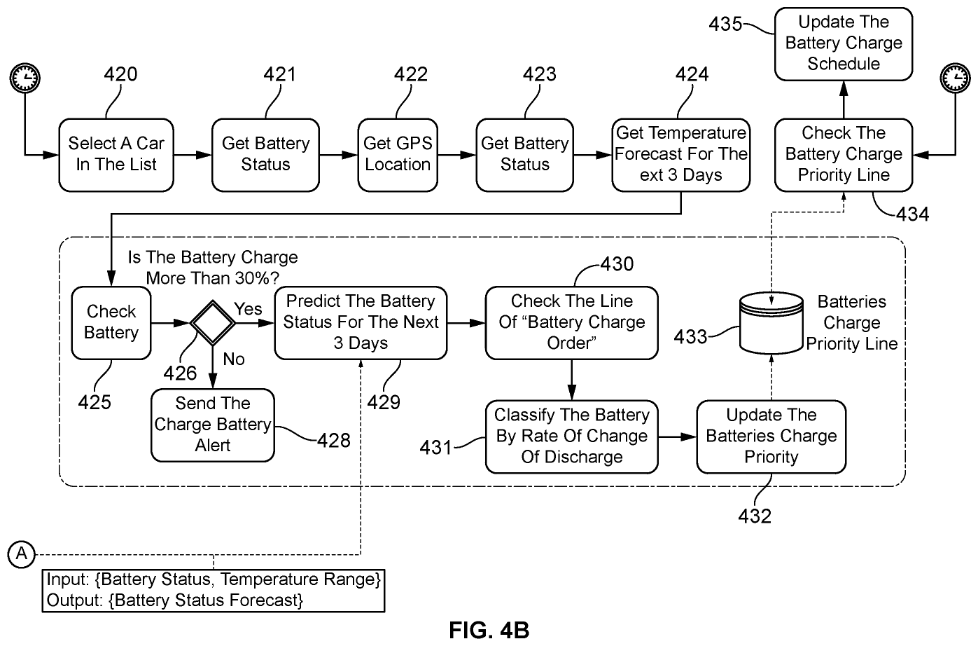

Referring to FIGS. 4A-4B, a flowchart 400 describes the process for forecasting data and predicting the battery charge depletion of a vehicle 102 using the machine learning algorithm is disclosed. At step 401, the machine learning module 116 could check for new data on the database 118 at each time. At step 402, the machine learning module 116 determines that the database 118 is updated with new data. If the database 118 is not updated with the new data then the machine learning module 116 could check for new data on the database 118 after an interval of time, at step 403. At step 408, the machine learning module 116 trains machine learning (ML) model for predicting the battery charge depletion of the vehicle if there is a new data on the database 118. At step 404, test the new ML model with the storical data. At step 405, the machine learning module 116 could check the ML model and determine whether it is better than the previous model. If the ML model is not better than the previous model then the machine learning module 116 trains another ML model at step 408. At step 406, update the ML model if it is better than the previous model. At step 407, the updated ML model is used for predicting the battery charge depletion of the vehicle.

At step 409, the machine learning module 116 retrieves all data from the database 118. The data includes, but not limited to, temperature, battery voltage, data and time, time of exposure to the temperature. At step 410, the machine learning module 116 could separate data stored in the database 118 into a training data (80% or any threshold percentage) and test and validation data (20% or any threshold percentage). At steps 411-413, the machine learning module 116 could run a linear regression machine learning using parameters and test by comparing the results of the new ML model with the results of the previous model. At step 414, the machine learning module 116 checks the results of the ML model and determine whether it is better than the previous model. If the results of the ML model are less efficient than the previous model then the parameters could be changed at step 415 and again runs the linear regression machine learning at step 411 using the changed parameters. At step 416, the new ML model is updated and stored in the database 118 at step 417 for predicting the battery charge depletion of the vehicle.

At step 420, the user or a person could select a vehicle, for example, a car, in the provided list via a user interface/graphical interface. At steps 421-424, the user could get battery status of the vehicle, GPS location, and temperature forecast for at least 3 days. At steps 425-426, the remote computing system 110 could check the battery status of the selected vehicle by the user. At step 428, the remote computing system 110 could send an alert to the user if the battery charge of the vehicle is less than 30% or any threshold percentage. At step 429, the remote computing system 110 could predict the battery status for next 3 day based on the inputs/parameters include, but not limited to, battery status and temperature range, and if the battery charge of the vehicle is greater than 30% or any threshold percentage. At step 430, the remote computing system 110 could check the line of battery charge order. At step 431, the system 100 could classify the vehicle's battery base on the rate of change of discharge. At step 432-433, the system 100 updates the batteries charge priority and stored in the database 118. At step 434-435, the remote computing system 110 could check the battery charge priority line and update the battery charge schedule and stores in the database 118.

In one embodiment, non-transitory physical computer storage could be provided that includes instructions stored thereon for implementing, in one or more processors. A method of managing the maintenance of batteries of a fleet of vehicles is disclosed. At one step, data is extracted from the analytical data module of each fleet vehicle. At another step, the extracted data is transmitted to a remote computing system from the analytical data module via a transmission module. At another step, the weather forecasts are determined for an area in which the vehicle is located using the weather forecast module. At another step, the extracted data and weather forecasts data are stored in a database of the remote computing system. Further, at step, the vehicle's battery charge depletion is detected and predicted based on the vehicle's extracted data and weather forecasts data for an area in which the vehicle is located using a battery depletion prediction module using a machine learning algorithm.

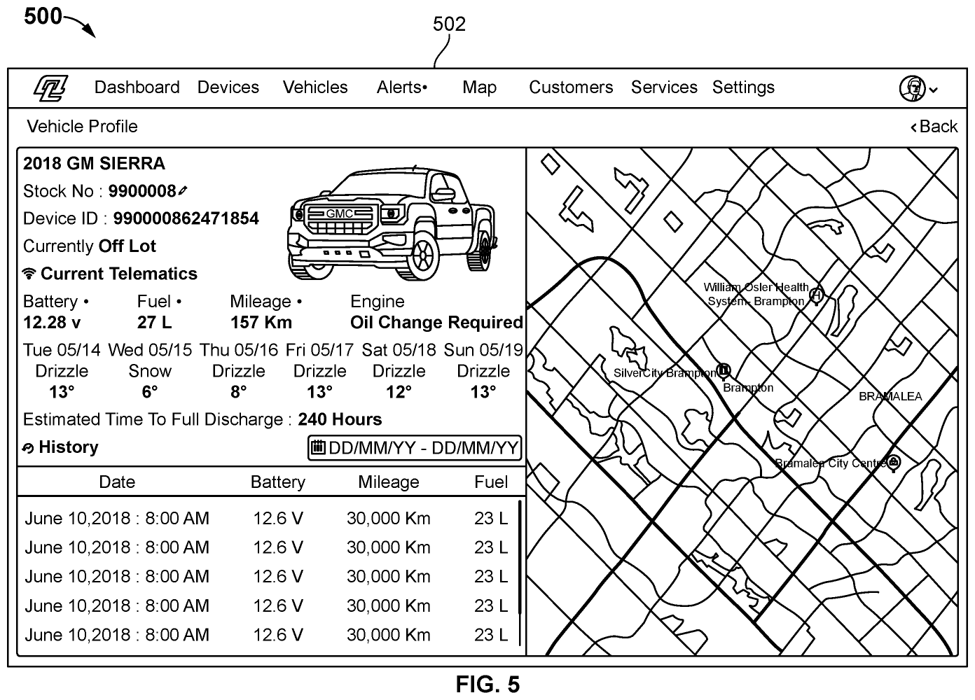

FIG. 5 exemplarily illustrates a screenshot 500 of a user interface/graphical interface of the remote computing system 110 is disclosed. In one embodiment, the remote computing system 110 further comprises a user interface. The user interface is at least any one of, but not limited to, a display and buttons. The user interface is configured to enable the user to select a fleet vehicle and get details, for example, a vehicle identification number, image, and model of the vehicle. The user could get the location on the map, and also the vehicle's analytical/telematic data, including, among others, battery status, fuel level, mileage, weather forecasts, and battery charge depletion prediction. The system 100 could extract the GPS coordinates of each vehicle and determines the weather forecasts in the exact location of each vehicle using the weather forecasts module 120. In one embodiment, the remote computing system 110 is further configured to connect to the user device 126, for example, a smartphone, to receive data related to the vehicle's location, predicted battery charge depletion, fuel level, and mileage of the vehicle 102. In one embodiment, the user device 126 is wirelessly communicated to the remote computing system 110 via a network using a software application. In one embodiment, the network is at least any one of, but not limited to, Wi-Fi, Bluetooth®, a wireless local area network (WLAN), and radio wave communication.

In one embodiment, the user could select different options from a navigation bar 502. The navigation bar 502 comprises a plurality of options, which enables navigation to a plurality of hierarchical screens. In one embodiment, the plurality of options includes a dashboard, devices, vehicles, alerts, map, customers, services, and settings. The navigation bar 502 further includes a user profile. A back option is provided adjacent to the navigation bar 502 for exiting from the present screen. Upon a selection of any one of the vehicles in the fleet, the vehicle profile displays the corresponding details of a vehicle, such as stack number, device ID, current telematics of vehicle, estimated time to the full discharge of battery and history of battery and fuel level. In one embodiment, the telematics of vehicle includes, but not limited to, battery level, fuel level, mileage, engine status, and weather conditions. Further, the history of the vehicle comprises date and time, battery voltage level, mileage, and fuel level. The system continuously monitors and predicts the risk of battery drainage and failure in the vehicle. The system provides alerts to the user prior to the full discharge of battery voltage, which enables the user to recharge the battery before it drained completely. In one embodiment, the alert is a message. In some embodiments, the alert could be light indications, text notifications, alarm and/or voice notifications.

Preferred embodiments of this invention are described herein, including the best mode known to the inventors for carrying out the invention. It should be understood that the illustrated embodiments are exemplary only and should not be taken as limiting the scope of the invention.

Although specific features of various embodiments of the invention may be shown in some drawings and not in others, this is for convenience only. In accordance with the principles of the invention, the feature(s) of one drawing may be combined with any or all of the features in any of the other drawings. The words “including,” “comprising,” “having,” and “with” as used herein are to be interpreted broadly and comprehensively, and are not limited to any physical interconnection. Moreover, any embodiments disclosed herein are not to be interpreted as the only possible embodiments. Rather, modifications and other embodiments are intended to be included within the scope of the appended claims.

1. A battery maintenance management system of a fleet of vehicle, comprising:
an analytical data module positioned in the vehicle, wherein the analytical data module is configured to extract data from the vehicle;
a weather forecast module configured to detect the weather forecasts for an area in which the vehicle is located;
a remote computing system configured to receive the extracted data from the analytical data module via a transmission module and weather forecasts including temperature and sunlight availability data from the weather forecast module and classify the vehicles according to the extracted data and generate a battery maintenance schedule for each vehicle,
wherein the remote computer system comprising:
a server configured to host communications between the remote computing system, the analytical data module, and the weather forecast module, wherein the server, comprising:
a battery depletion prediction module configured to detect and predict the vehicle's battery charge depletion based on the vehicle's extracted data and weather forecasts data for an area in which the vehicle is located;
a database configured to store the extracted data and weather forecasts data received from the analytical data module and the weather forecast module, respectively, and
a machine learning module configured to test and update the database and forecast the extracted data and weather forecasts data received from the analytical data module in real-time and the weather forecast module, respectively.

2. The system of claim 1, wherein the extracted data from the analytical data module includes a vehicle identification number, fuel level, battery level, vehicle mileage, and GPS location.

3. The system of claim 1, wherein the analytical data module is at least any one of an onboard computer system, a vehicle operating system, and an onboard diagnostics (OBD).

4. The system of claim 1, wherein the analytical data module is configured to wirelessly communicate to the server of the remote computing system in real-time via a real-time operating system (RTOS) and the transmission module.

5. The system of claim 1, wherein the transmission module comprises a cellular chip.

6. The system of claim 1, wherein the remote computing system is further configured to connect to a user device via an application programming interface (API) to transfer data related to the vehicle's location, predicted battery charge depletion, fuel level, and mileage of the vehicle.

7. The system of claim 6, wherein the user device is at least any one of a desktop, a laptop, a tablet, a smartphone, a personal digital assistant (PDA), and mobile and/or handheld electronic device.

8. The system of claim 1, wherein the battery depletion prediction module detects and predicts the vehicle's battery charge depletion using a machine learning algorithm.

9. The system of claim 1, wherein the weather forecast module is further connected to a weather forecast service provider to retrieve the meteorological information associated with the location of each vehicle.

10. The system of claim 1, wherein the weather forecast module is an application programming interface (API).

11. The system of claim 1, wherein the vehicle is at least any one of cars, trucks, buses, semi-trucks, semi-trucks with trailer, tractor trailers, trailers, recreational vehicles (RVs), sport utility vehicle SUVs, campers, limousines, cabs, and vans.

12. A method of managing a battery of a vehicle, comprising:
extracting data from an analytical data module of each fleet vehicle;
transmitting the extracted data to a remote computing system from the analytical data module via a transmission module;
determining weather forecasts for an area in which the vehicle is located using a weather forecast module;
storing the extracted data and weather forecasts data in a database of the remote computing system received from the analytical data module and the weather forecast module, respectively, and
detecting and predicting the vehicle's battery charge depletion based on the vehicle's extracted data and weather forecasts data for an area in which the vehicle is located using a battery depletion prediction module using a machine learning algorithm.

13. The method of claim 12, wherein the extracted data from the analytical data module includes a vehicle identification number, fuel level, battery level, vehicle mileage, and GPS location.

14. The method of claim 12, wherein the analytical data module is at least any one of an onboard computer system, a vehicle operating system, and an onboard diagnostics (OBD).

15. The method of claim 12, wherein the analytical data module is configured to wirelessly communicate to the server of the remote computing system in real-time via a real-time operating system (RTOS) and the transmission module.

16. The method of claim 12, wherein the remote computing system is further configured to connect to a user device via an application programming interface (API) to transfer data related to the vehicle's location, battery charge depletion, fuel level, and mileage of the vehicle.

17. The method of claim 16, wherein the user device is at least any one of a desktop, a laptop, a tablet, a smartphone, a personal digital assistant (PDA), and a computer.

18. The method of claim 12, wherein the weather forecast module is further connected to a weather forecast service provider to retrieve the meteorological information associated with the location of each vehicle, wherein the weather forecast module is an application programming interface (API).

19. The method of claim 12, wherein the vehicle is at least any one of cars, trucks, buses, semi-trucks, semi-trucks with trailer, tractor trailers, trailers, recreational vehicles (RVs), sport utility vehicle SUVs, campers, limousines, cabs, and vans.

20. A non-transitory physical computer storage can be provided that includes instructions stored thereon for implementing, in one or more processors, a method of managing the maintenance of batteries of a fleet of vehicles, comprising:
extracting data from an analytical data module of each fleet vehicle;
transmitting the extracted data to a remote computing system from the analytical data module via a transmission module;
determining weather forecasts for an area in which the vehicle is located using a weather forecast module;
storing the extracted data and weather forecasts data in a database of the remote computing system received from the analytical data module and the weather forecast module, respectively, and
detecting and predicting the vehicle's battery charge depletion based on the vehicle's extracted data and weather forecasts data for an area in which the vehicle is located using a battery depletion prediction module using a machine learning algorithm.
